(19) United States
(12) Patent Application Publication
(10) Pub. No.: US 2026/0203173 A1
(43) Pub. Date: Jul. 16, 2026

(54) ATOMIC BACKUP CONSISTENCY GROUPING ACROSS DATASETS

(71) Applicant: HYCU, Inc., Boston, MA (US)

(72) Inventors: Sathya Sankaran, Boston, MA (US); Subbiah Sundaram, Boston, MA (US); Mladen Brajkovic, Ljubljana (SI)

(21) Appl. No.: 19/435,151

(22) Filed: Dec. 29, 2025

Related U.S. Application Data
(60) Provisional application No. 63/740,177, filed on Dec. 30, 2024.

(51) Int. Cl. G06F 11/1446

(52) U.S. Cl. CPC G06F 11/1469; G06F 2201/84

(57) ABSTRACT

Atomic backup sets identify data objects that are grouped together and from the same point in time. These atomic backup sets are leveraged when invoking a data protection service. The approach is particularly useful for maximizing data integrity and consistency across related datasets, such as for managed analytics platforms, while avoiding the overhead associated with other techniques.

### CROSS REFERENCE TO RELATED APPLICATIONS

This application claims priority to U.S. Provisional Application No. 63/740,177 filed on Dec. 30, 2024 the entire contents of which are hereby incorporated by reference in their entirety.

### BACKGROUND

Data loss in database and data analytics platforms is a serious problem and can occur for various reasons. Here are some common scenarios:
Zone-Level and Lower-Level Failures: Hardware or network issues in a specific zone can make your data unavailable or even lost if it's not replicated across other zones.
Regional Failures: Major events like natural disasters can affect an entire region. If your backups are only stored there, you might lose access to your data when you need it most.
Bugs in SQL Code: Small errors in SQL queries can accidentally delete or corrupt data if safeguards aren't in place.
Human Error: Accidental deletions or misconfigurations can lead to unintended data loss.
Insider Threats: Authorized individuals might intentionally delete or leak data, posing serious risks to your data's security.
Record Expiration: Some records are set to automatically expire based on a default expiration policy even though they have utility past the default window for purposes such as eDiscovery, Trend analysis etc.

Traditionally, data warehouses are a copy of transformed data from multiple sources, and many times there is a question as to why they even need to be separately backed up. However, an important consideration in protecting data warehouses is to factor in the time taken and the costs involved in recreating the warehouse if there is sustained data loss. Costs include:
ETL(EXTRACT, TRANSFORM, LOAD)
Streaming
API (Application Programming Interface) management
PIPELINE SERVICES, EGRESS, AND MORE.

In addition, with massive scale data warehouse systems, many customers rely on real time event streaming to populate the data warehouse. Therefore, recreating it would not even be possible—because the only copy of data was stored as it was streamed, and once that copy is lost, the streaming data is also lost forever.

Modern regulations like the Digital Operations Resilience Act (DORA) require a larger failure domain for critical applications. Regulated industries, like healthcare and financials, are also subject to compliance, long-term retention, and durability requirements.

Review of the following documents may be helpful in understanding existing systems.

U.S. Pat. No. 10,210,050 describes grouping one or more “save sets” into a “consistency group” and performing backup and recovery operations over the consistency group.

US Patent Publication 20190332499 A1 teaches creating, at a first point-in-time, a set of snapshots for volumes in a consistency group, and generating snapshot metadata which includes identifiers (snapshot set identifier and consistency group identifier).

Google's BigQuery “Managed Disaster Recovery”, as of Dec. 11, 2024, provides managed failover/redundant compute and (ii) cross-region dataset replication enabling replication of a dataset from a source region to one or more other regions.

Amazon Web Services “What's New”, Nov. 15, 2024, explains that AWS Backup uses metadata (tags) and policy constructs to select and protect resources in a managed service.

### BRIEF SUMMARY

### Problems Recognized

While data warehouses can easily handle massive datasets, it is common for users to segment their data into several datasets. This segmentation offers them better control over:
Data Organization and Management
Granular Access Control
Performance and Query Optimization
Query Cost Management
Data Lifecycle/record Expiration Management

Even with segmented datasets, such as is possible within BigQuery, there are several ways to analyze and mine data across these datasets through federated queries, cross-dataset joins, views etc. Views are virtual tables that provide a way to encapsulate complex queries and present them as simple tables. This is particularly useful for creating reusable queries that can be shared across different teams and often becomes the primary method through which data is consumed by BigQuery users.

During backup, it is therefore important that these underlying datasets are protected with a version from the same point in time to make these views reliable.

Another key point to note is that as these datasets get larger, traditional backups create larger inconsistency windows and thus making these atomic backup sets more critical.

It is also important to note that exporting data from an analytics platform such as BigQuery does not include metadata, such as Time Travel data. Thus the data set cannot be retraced back to a consistent point. As a result, having an ability to create coordinated consistency at the time of backup is critically important.

### Solutions

A technique referred to as “atomic backup sets” allows users to group datasets in a particular way and to ensure they are backed up at the same point in time across an entire set. This approach is particularly useful for maintaining data integrity across related datasets.

Unlike traditional consistency groups that rely on storage-level primitives (e.g., volume snapshots), the disclosed system creates an external, platform-agnostic consistency grouping and enforces group-level atomicity through logical ‘as-of’ resolution and metadata binding.

Atomic backup sets can be provided for by maintaining metadata, such as an “atomic-backup-set” label, for associated datasets tagged within a data protection system such as a cloud-based backup system.

More particularly, the “atomic-backup-set” label lets the user define which datasets should be grouped together. When a backup is initiated, all datasets with the same atomic-backup-set label value are then protected using the same point in time, ensuring consistency grouping across the user's data. This approach is an improvement as compared to how datasets are captured at different points of time through the maintenance of queues, rate limits and differing schedules.

The following steps may be performed, in one embodiment:
Label the Datasets: Add an atomic-backup-set label to the datasets to be protected together within the data warehouse. For example, this metadata may be added within BigQuery itself. Group membership may also be defined using policy rules, external catalogs, naming conventions, or other metadata constructs. The data protection system, such as HYCU R-Cloud, can then discover the datasets that carry the same group name, and then treat them together as an atomic backup set. The new group can also be displayed in a User Interface (UI) as a unique virtual container.
Associate Policy: Associate a desired backup policy to the new group in the data protection system. When the policy kicks off backup for BigQuery, R-Cloud may then automatically group and backup the BigQuery datasets with the same atomic-backup-set label at the same point in time.

With this approach, recovery options remain flexible. For example, users can continue to restore individual datasets and tables, to the same project or a different project with the same name or a new name. Any dataset that is part of the Atomic Backup Set will have recovery points that were protected at the same point in time. When datasets are restored, the views and routines that could be cross-referencing these datasets are also restored along with it.

### Advantages

By leveraging consistency groupings and atomic backups, it is now possible to ensure that datasets are consistent, reliable, and easier to manage. Whether dealing with large-scale data analysis, trending, mining on historical data, or simply a need to maintain data integrity, Atomic Backup Sets provide a robust solution.

Data integrity is improved. Using atomic backup sets ensures that related datasets are consistent with each other, preventing discrepancies that can arise from exporting datasets at different times. Views that reference tables in other datasets are common and exporting these dependent datasets together help achieve better consistency.

Grouping datasets makes it easier to manage and organize data exports.

By protecting datasets at the same point in time, the risk of data mismatches is reduced, and the reliability of data analysis is improved.

### BRIEF DESCRIPTION OF THE DRAWINGS

FIG. 1 illustrates an example of cloud analytics and data protection architecture in which a managed analytics platform provides atomic dataset services.

FIG. 2 Illustrates an Example Dataset That Includes One or More Labels.

FIG. 3 shows how a protection policy is associated with a virtual container representing the atomic backup set.

FIG. 4 is an example workflow for handling atomic datasets.

FIG. 5 is workflow for heterogeneous environments.

### DETAILED DESCRIPTION OF PREFERRED EMBODIMENTS

The following description sets forth specific embodiments for implementing atomic backup sets in cloud-based analytics environments. The embodiments are provided to enable persons skilled in the art to make and use the disclosed subject matter and are not intended to limit the scope of the claims.

### 1. System Overview

In one embodiment, a data protection system provides coordinated protection and recovery for a plurality of datasets maintained by a managed analytics platform. In this embodiment, an “atomic backup set” is a logical grouping of datasets that are to be protected such that each dataset in the grouping is backed up as of a common point in time (sometimes referred to herein as an “anchor point” or “anchor timestamp”). This coordinated point-in-time protection mitigates inconsistency that may otherwise arise when analytical objects (e.g., views, routines, and cross-dataset joins) reference multiple datasets that are backed up at different times.

In preferred embodiments, atomic backup sets are implemented by (i) declaring group membership via dataset metadata labels, (ii) representing the group as a virtual container for policy and operations, (iii) enforcing a common restore time (“anchor point’) for coordinated backups across all member datasets, and (iv) enabling restores that preserve cross-dataset correctness, including restoration and optional translation of dependent objects. The embodiments provide a practical and provider-integrated mechanism for reducing cross-dataset inconsistencies during backup and recovery in cloud analytics deployments.

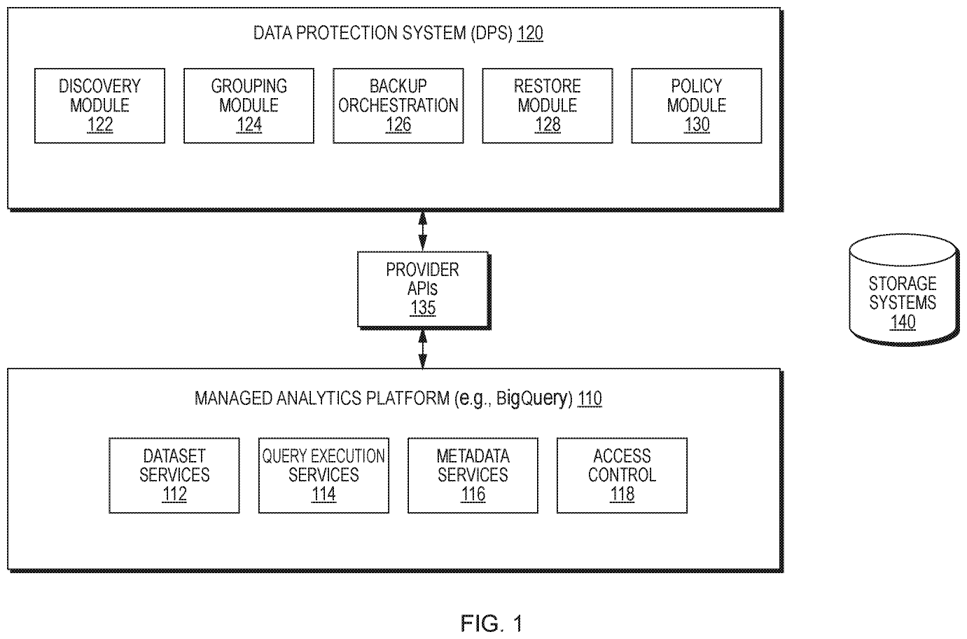

FIG. 1 illustrates an example cloud analytics architecture 100 in which a Managed Analytics Platform 110 provides Dataset Services 112, Query Execution Services 114, Metadata Services 116, and Access Control Services 118. The Managed Analytics Platform 110 is typically implemented as a provider-operated multi-tenant service that exposes administrative and data APIs.

While Google BigQuery is a non-limiting example platform 110, the disclosed techniques are applicable to managed analytics services and other data management platforms, including those that do not natively support multi-object consistency grouping.

In one embodiment, a Data Protection System (DPS) 120 interfaces with the managed analytics platform 110 via one or more provider Application Programming Interfaces (APIs) 135. The DPS 120 may further interface with one or more storage systems 140 (e.g., object storage) for persisting backups, manifests, and related metadata. This example DPS 120 includes a Discovery Module 122, a Grouping Module 124, a Backup Orchestration Module 126, a Restore Module 128, and a Policy Module 130.

### 2. Example Computing Implementation

In one embodiment, the DPS 120 comprises one or more processors and memory storing instructions that, when executed, perform discovery, data resilience, backup orchestration, and restore operations. The DPS 120 may be implemented as a cloud service, a containerized application, a virtual appliance, or any combination thereof.

The DPS 120 may include functional modules such as:
a Discovery Module 122 configured to enumerate datasets and dataset metadata;
a Grouping Module 124 configured to form atomic backup sets based on metadata labels and/or policy configuration;
a Backup Orchestration Module 126 configured to create coordinated recovery points across the atomic backup set;
a Restore Module 128 configured to restore datasets and dependent objects, including optional name translation; and
a Policy Module 130 configured to apply scheduling, retention, and access constraints to backup operations.

These modules are shown as logical partitions and may be combined, subdivided, or distributed across multiple services.

### 3. Atomic Backup Set Membership Via Dataset Labels

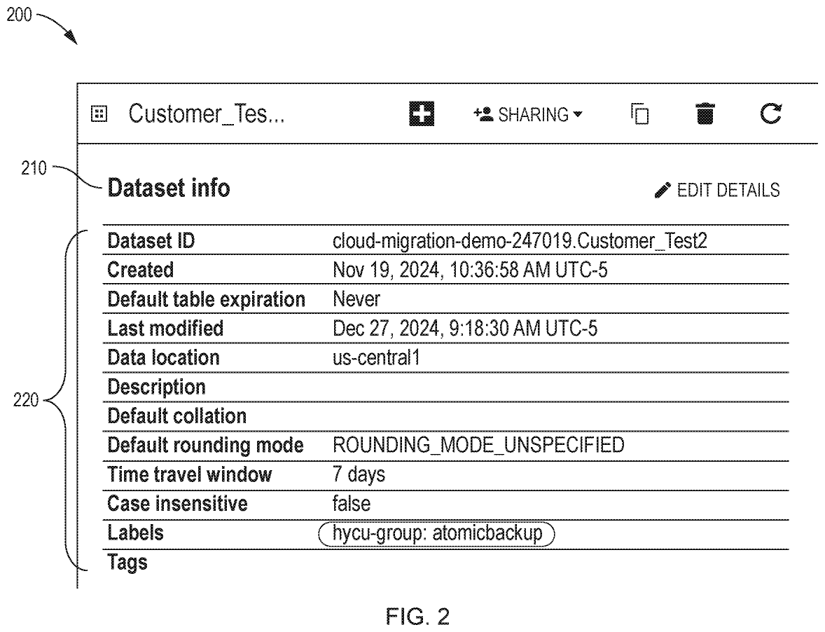

In one embodiment, membership in an atomic backup set is declared by applying a metadata label to each dataset intended to be protected together. Group membership may also be defined using policy rules, external catalogs, naming conventions, or other metadata constructs. FIG. 2 illustrates an example administrative interface 200 in which a dataset 210 includes one or more labels 220. A label may be represented as a key-value pair (e.g., atomic-backup-set=<GroupIdentifier>), though the invention is not limited to any particular grouping mechanism or naming.

The DPS 120 may treat all datasets sharing the same group identifier as members of the same atomic backup set.

In one embodiment, the Discovery Module 122 periodically queries the Managed Analytics Platform 110 to obtain dataset metadata and identifies member datasets by matching label keys and/or values to a configured selector. The selector may be exact-match, prefix-match, regular expression match, or other rule-based matching.

In one embodiment, the DPS 120 represents an atomic backup set as a “virtual container” (or similar construct) that provides a single management surface for policy assignment, monitoring, and recovery operations.

In some embodiments, the DPS 120 maintains, in memory and/or in persistent storage, a Resource Catalog 132 (also referred to herein as a “service data definition”) that represents managed analytics resources discovered from the managed analytics platform 110. The Resource Catalog 132 may comprise a plurality of resource objects corresponding to a hierarchy of managed analytics datasets and subordinate objects, such as, by way of example, a tenant or account, a project, a dataset, and subordinate dataset objects including tables, views, materialized views, user-defined functions, stored procedures, and other routines. For each resource object, the Resource Catalog 132 stores a set of attributes obtained from the Managed Analytics Platform 110 via one or more administrative and data APIs (e.g., the Provider APIs 135), including one or more of: an identifier, a name, a type, a location or region, access control information, schema metadata, and user-defined metadata such as labels. In preferred embodiments, the resource catalog stores an atomic backup set attribute for each dataset resource object, such that datasets having a common group identifier are programmatically discoverable as members of a common atomic backup set, thereby enabling coordinated data protection operations across the grouped datasets.

In further embodiments, the Resource Catalog 132 is utilized by the DPS 120 to drive orchestration decisions during backup and restore operations. For example, the resource catalog may store capability attributes indicating whether the managed analytics platform 110 supports a provider-side data protection method for a given resource type (e.g., dataset-level export or snapshot semantics), and may further store dependency-related attributes such as whether a dataset resource has subordinate resources and/or references to dependent objects (e.g., view definitions referencing objects in other datasets). During a protection run, the DPS 120 may query the Resource Catalog 132 to enumerate the member datasets of a selected atomic backup set, determine an anchor point for the run, and invoke the provider-side data protection method for each member dataset as-of the anchor point. In some implementations, the DPS 120 updates the resource catalog with execution metadata for the run, such as backup artifact identifiers, a manifest identifier, and a validity indicator reflecting whether a coordinated recovery point was successfully created across all member datasets. During restoration, the DPS 120 may consult the resource catalog to apply a restore sequence that recreates dataset containers, restores subordinate objects, and restores or validates dependent objects such as views and routines, including optional translation of identifiers when restoring to a different project or dataset name.

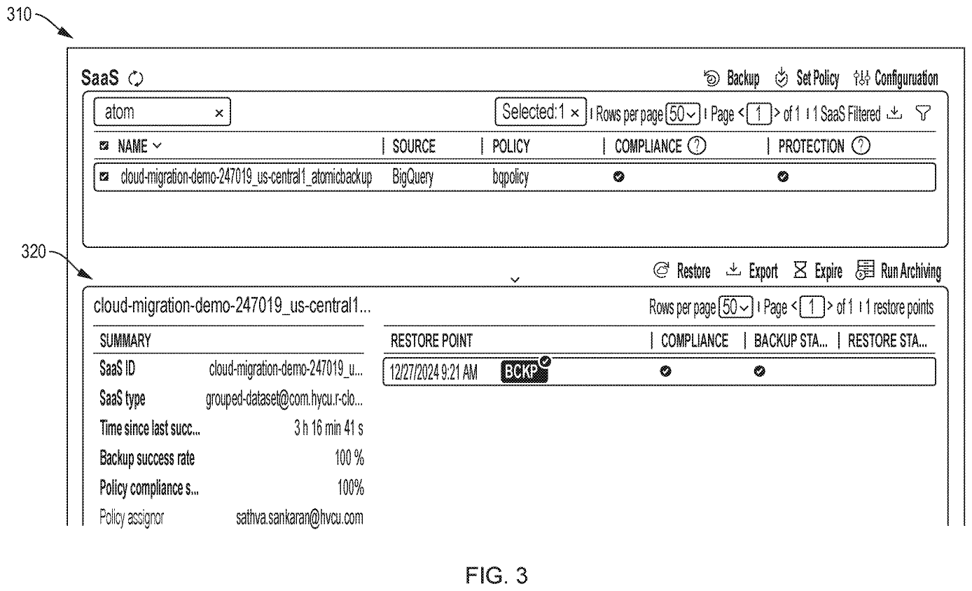

FIG. 3 illustrates an example in which a Virtual Container 310 corresponds to an atomic backup set and is associated with a Protection Policy 320.

### 4. Establishing Consistency

In preferred embodiments, the DPS 120 enforces consistency for atomic backup sets. In one embodiment, for a given backup run, the DPS 120 establishes a single “anchor point” and ensures that each member dataset is backed up as-of that anchor point.

The anchor point may be represented as one or more of:
a platform-supported point-in-time identifier (e.g., a snapshot time, version, or transaction timestamp);
a DPS-generated logical timestamp captured at orchestration start; and/or
a composite identifier recorded in a backup manifest, as described below.

The specific mechanism used to implement “as-of” semantics may vary by platform. Where platform primitives provide consistent snapshot reads, the DPS 120 leverages those primitives. Where platform primitives are not available, the DPS may coordinate extraction to improve backup duration and operational efficiency; however, atomicity is provided by logical version resolution to the anchor point (T) and metadata binding, rather than by physical simultaneity.

### 5. Coordinated Backup Workflow

In one embodiment, the Backup Orchestration Module 126 performs an atomic backup set backup operation as follows:
Enumerate Membership. The Grouping Module 124 may identify a set of member datasets {D1 . . . Dn} based on label discovery and/or policy configuration.
Select Anchor Point. The DPS 120 may select an anchor point T for the backup run. In some implementations, T corresponds to a provider-supported snapshot time; in other implementations, T corresponds to an orchestration timestamp recorded in a metadata manifest.
Initiate Dataset Backups. The DPS 120 initiates backup operations for each member dataset as-of T. In one embodiment, the DPS 120 performs exports of tables and associated metadata 150 (which may be a manifest describing schemas, table properties, partitioning/clustering definitions, ACLs as permitted, and other dataset metadata) to Backup Storage 140.
Capture Dependent Objects. In one embodiment, the DPS 120 additionally captures definitions for views, materialized views, functions, procedures, and routines associated with the member datasets.
Finalize and Validate. The DPS 120 validates that the backup operations for all member datasets correspond to the common anchor point T and meet completeness criteria.

### 5.1 Atomic Restore-Point Metadata

In one preferred embodiment, the DPS 120 generates “atomic restore-point metadata/manifest” 150 for each backup run. The metadata manifest 150 may include: the atomic backup set identifier; the anchor point T; a list of member datasets and their respective backup artifact identifiers; optional integrity data such as hashes, object counts, or metadata fingerprints; and a validity indicator (e.g., “atomic-valid” or “atomic-invalid”).

The metadata 150 provides a durable record enabling the restore module 128 to select recovery points that are consistent across all member datasets.

### 5.2 Handling Partial Failure

In one embodiment, if backup of any member dataset fails, the DPS 120 marks the run as non-atomic (e.g., “atomic-invalid”) in the manifest and/or user interface. In another embodiment, the DPS 120 may retry failed members while preserving the original anchor point T, thereby maintaining atomicity once all members succeed. In some implementations, upon retry the DPS re-validates that T remains accessible, and if not, marks the restore point atomic-invalid or selects a new T.

### 6. Restore and Recovery Operations

In one embodiment, the Restore Module 128 supports restoration at multiple granularities, including: restoration of a full atomic backup set (all member datasets); restoration of one or more individual datasets within the set; and /r restoration of selected tables within a dataset.

In one embodiment, the Restore Module 128 supports restoring to: the same cloud project/account/tenant as the source; a different cloud project/account/tenant; and/or the same dataset names or substituted names.

In preferred embodiments, restoring the analytical layer is treated as a first-class objective. Accordingly, when restoring one or more datasets, the DPS 120 may restore associated view and routine definitions captured during backup.

In one embodiment, when restoring to a different namespace (e.g., different project or different dataset name), the Restore Module 128 performs reference translation to update dependent object definitions to refer to restored targets rather than original source identifiers. The Restore Module 128 may validate compilation of restored views/routines and report any failures.

In one embodiment, where the user initiates restore from a given point, the DPS 120 selects recovery artifacts using the Manifest 150 to ensure the selected point corresponds to a common anchor point T across all members. If the user requests a restore that would violate atomic consistency (e.g., restoring a single dataset from an atomic-valid restore point without companion datasets), the DPS 120 may present a warning and/or recommend restoring the full atomic backup set.

### 7. Policy Association

In one embodiment, a protection policy 320 (FIG. 3) is associated with the Virtual Container 310 representing the atomic backup set. The policy may define: backup frequency and schedule; retention duration; storage targets and replication settings; and/or access controls and operational constraints.

Upon policy trigger, the Backup Orchestration Module 126 initiates the coordinated backup workflow described above.

### 8. Security and Access Control Considerations

In one embodiment, the DPS 120 uses least-privilege credentials (e.g., a service account) to access dataset metadata and data exports. The DPS 120 may integrate with cloud IAM services to enforce administrative boundaries and auditability. Backup artifacts may be encrypted at rest and in transit, and access to restore operations may be restricted to authorized roles.

### 9. Optional Variations

The following enhancements may be included in certain embodiments:
Dependency Closure. The DPS 120 may parse view definitions and routine references to discover additional referenced datasets and suggest or automatically include them in an atomic backup set.
Streaming/Ingress Coordination Hooks. The DPS 120 may coordinate with ingestion pipelines (e.g., streaming writers) by invoking pre-backup and post-backup hooks to bound in-flight changes, thereby strengthening practical consistency for high-ingest environments.
Cross-Project and Cross-Region Constraints. The DPS 120 may validate that datasets within an atomic backup set satisfy platform constraints (e.g., location boundaries) and provide guided remediation where constraints prevent a unified set.
Drift Detection. The DPS 120 may detect when datasets are added/removed from a set (e.g., label changes) and alert operators or enforce approvals.

### 10. Resolving “as-of” State for Atomic Consistency and Other Variations

Returning to FIG. 1, in certain embodiments the Data Protection System (DPS) 120 provides atomic protection of a plurality of data objects of a managed analytics platform 110 (e.g., BigQuery) by resolving a consistent “as-of” state for each member of an atomic backup set, rather than by pausing ingestion, acquiring global locks, or enforcing transactional coordination across objects.

In some implementations, the DPS 120 establishes an anchor point (also referred to as a reference timestamp T) for an atomic backup set, and the Backup Orchestration Module 126 performs logical version resolution for each data object in the atomic backup set to identify (or derive) a corresponding object version consistent with T. In this manner, the DPS 120 provides group-level atomicity by ensuring each member object is backed up from a version corresponding to the same anchor point, even where the physical extraction and export of backup artifacts occurs over a time interval during which the managed analytics platform 110 continues to process updates. In some embodiments, the order in which objects are exported does not affect atomicity, because each object is resolved to its respective “as-of T” version independent of capture order.

In some embodiments, the DPS 120 operates as an external logical abstraction layer over the managed analytics platform 110. For example, the Grouping Module 124 forms an atomic backup set using dataset metadata and/or other attributes obtained via Provider APIs 135, without requiring the managed analytics platform 110 to natively support multi-object consistency groups, grouped snapshots, or multi-object transactional boundaries. In some implementations, the DPS 120 maintains a platform-agnostic representation of group membership and version semantics (e.g., T and per-object resolved versions), while mapping such semantics to platform-specific constructs (e.g., snapshot identifiers, commit markers, or other version indicators) at backup time.

In some embodiments, the protected “data objects” include not only datasets but also subordinate or related objects such as tables, partitions, and file-like objects (including logical collections thereof). In such embodiments, the Discovery Module 122 may enumerate datasets and subordinate objects using the Dataset Services 112 and/or Metadata Services 116 of the managed analytics platform 110, and the Backup Orchestration Module 126 may generate backup artifacts for one or more subordinate objects as-of the anchor point T, thereby extending atomic consistency across multiple object granularities.

Also, the anchor point T may, optionally, be determined in accordance with a policy administered by the Policy Module 130, and may be derived from multiple sources. For example, T may be (i) generated at backup initiation; (ii) explicitly supplied by an administrator or customer policy; or (iii) derived from a business event (e.g., an operational cutoff). In further implementations, the DPS 120 validates the selected T against platform constraints, including version-history retention constraints. For example, as shown in FIG. 2, dataset configuration information may include a “Time travel window” and other properties that bound historical version access. The Policy Module 130 and/or Backup Orchestration Module 126 may validate that T is within the available version-history window for each member dataset (and, in some cases, subordinate objects), and responsive to a validation failure, may adjust T to a valid timestamp, may exclude an object from an atomic-valid determination, and/or may generate an indication that the requested atomic restore point cannot be constructed as specified.

In some embodiments, the Backup Orchestration Module 126 resolves object versions corresponding to T using native storage platform historical-access mechanisms where available. In other embodiments, where native “as-of” access is unavailable for a given object or platform, the DPS 120 may derive a corresponding object version using external or auxiliary sources of version history, including change-data-capture (CDC) logs, write-ahead logs (WAL), incremental backup metadata, object-versioning records, and/or transaction or commit metadata. In such embodiments, the DPS 120 may materialize the object state as-of T by applying deltas up to T, rolling back changes after T, selecting a preceding checkpoint and applying subsequent changes through T, or by other reconstruction techniques sufficient to produce a logically consistent representation of the object at T.

Concurrent or long-running operations may be handled using version metadata. For example, the Backup Orchestration Module 126 may interpret commit identifiers, transaction bounds, snapshot sequence numbers, and/or log offsets to determine whether effects of an operation are included in an object version corresponding to T. In such implementations, the DPS 120 includes changes committed at or before T and excludes changes committed after T, regardless of when physical export occurs.

In some embodiments, the DPS 120 persists metadata that enables deterministic and auditable restore operations. For example, the Backup Orchestration Module 126 may write, to Storage Systems 140, a manifest and/or metadata record that associates: (i) an atomic backup set identifier; (ii) the anchor point T; (iii) object identifiers for each protected member object; and (iv) snapshot-resolution information sufficient to reproduce the mapping from each object to the version actually backed up (e.g., snapshot identifiers, commit identifiers, transaction bounds, log offsets, checkpoint identifiers, and/or reconstruction parameters used to derive the “as-of T” state). Such metadata permits later verification that each backed-up object corresponds to T and permits repeatable restoration that reproduces the same logical group state.

In some embodiments, the foregoing controls are implemented via a management interface, such as the SaaS interface shown in FIG. 3, which may present an atomic backup set (e.g., an “atom” grouping) as a managed unit for protection and restore. In some implementations, the interface displays protection state and restore points, and permits a user to initiate a restore associated with a particular group-level restore point corresponding to T. The DPS 120 may, via the Restore Module 128, use the persisted snapshot-resolution information to restore each object to its resolved version corresponding to T, thereby producing a group-level restore that is both deterministic and auditable.

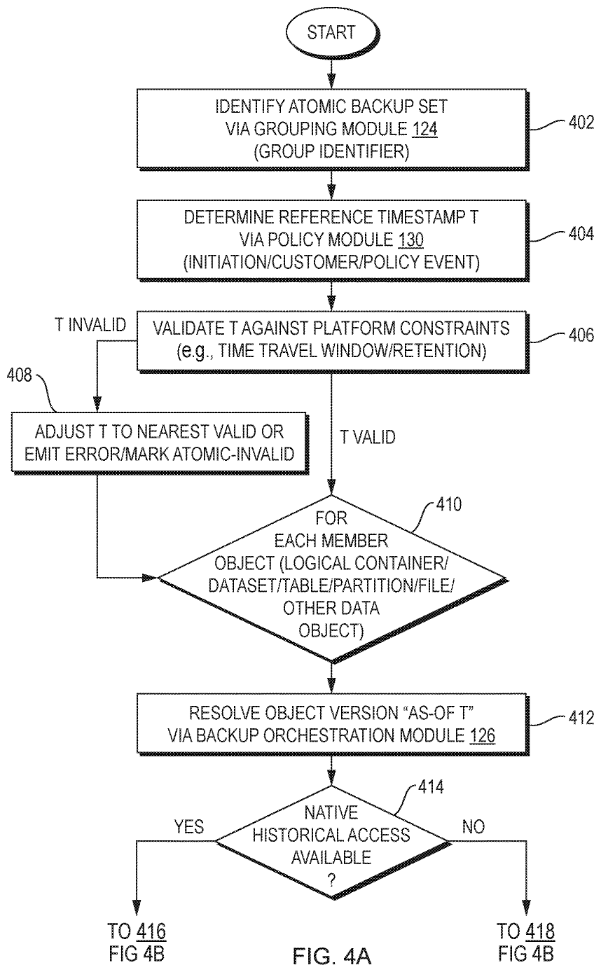

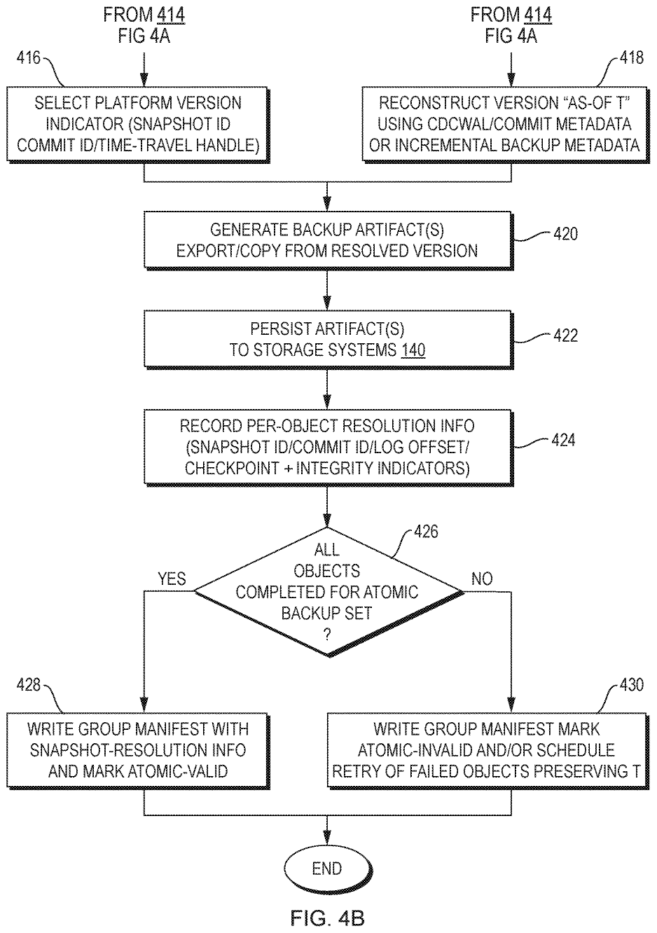

FIG. 4 illustrates an example process in more detail. At step 402, the DPS 120 identifies an atomic backup set, for example by selecting datasets and/or other data objects that share a common group identifier as determined by the Grouping Module 124 based on metadata obtained via one or more provider APIs. At step 404, the DPS 120 determines a reference timestamp T (also referred to as an anchor point) for the atomic backup set. In some implementations, step 404 is performed by the Policy Module 130 based on one or more of (i) a timestamp generated at backup initiation, (ii) a timestamp provided by a customer or policy, and/or (iii) a timestamp derived from a business event.

At step 406, the DPS 120 validates the reference timestamp T against platform constraints applicable to one or more members of the atomic backup set, such as version-history retention constraints, time-travel window constraints, or other historical-access limitations. If the reference timestamp T is determined to be invalid with respect to a platform constraint, the process may proceed to step 408, in which the DPS 120 adjusts T (e.g., to a nearest valid timestamp) and/or emits an error or status indication that the backup run cannot be atomic-valid for the requested T.

At step 410, the DPS 120 iterates through the member objects of the atomic backup set, which may include datasets and, in some embodiments, subordinate or related objects such as tables, partitions, files, or logical collections thereof. At step 412, for a given member object, the DPS 120 resolves an object version corresponding to the reference timestamp T (i.e., the object state “as-of T”), for example under control of the Backup Orchestration Module 126.

At decision step 414, the DPS 120 determines whether the underlying platform provides native historical access for the member object (e.g., time-travel access, a snapshot identifier, a versioned-table construct, or a commit-based version handle). If native historical access is available, the process proceeds to step 416, in which the DPS 120 selects a platform version indicator corresponding to the object state as-of T, such as a snapshot ID, commit ID, transaction-bound representation, or time-travel handle. If native historical access is not available, the process proceeds to step 418, in which the DPS 120 reconstructs the object state as-of T using one or more auxiliary sources of version history or change history, including, by way of example, change data capture (CDC) logs, write-ahead logs (WAL), incremental backup metadata, object versioning records, and/or transaction or commit metadata. In some implementations of step 418, reconstruction includes replaying changes up to T, rolling back changes after T, selecting a checkpoint and applying deltas through T, or other techniques sufficient to materialize a logically consistent representation of the object as-of T.

At step 420, the DPS 120 generates one or more backup artifacts for the member object from the resolved object version (whether obtained via step 416 or step 418). At step 422, the DPS 120 persists the generated backup artifacts to one or more Storage Systems 140. At step 424, the DPS 120 records per-object resolution information sufficient to later reproduce and/or audit the version selection for that object, such as the snapshot ID, commit ID, transaction bounds, log offset, checkpoint identifier, and/or reconstruction parameters, optionally together with integrity indicators (e.g., hashes, counts, or fingerprints).

At decision step 426, the DPS 120 determines whether backup artifact generation has completed successfully for all member objects of the atomic backup set for the reference timestamp T. If all member objects are completed, the process proceeds to step 428, in which the DPS 120 writes a group-level manifest including snapshot-resolution information for the atomic backup set and marks the backup run atomic-valid. If one or more member objects are not completed, the process proceeds to step 430, in which the DPS 120 writes a group-level manifest marking the backup run atomic-invalid and/or schedules retry of the failed member objects while preserving the reference timestamp T such that a subsequent completion can correspond to the same group-level restore point.

### 10.1 Bigquery Time Travel Snapshot Embodiment (Non-Limiting)

In one embodiment, the managed analytics platform comprises Google BigQuery and provides native time travel functionality that permits queries against historical table states. For a selected atomic backup set and reference timestamp T, the DPS resolves each table to its state as of T using time travel semantics. For example, for each table in the backup set, the DPS may execute a query of the form: SELECT * FROM <table> FOR SYSTEM_TIME AS OF TIMESTAMP(T) and may either (i) materialize the results into a snapshot table (e.g., <table>_hycu_snapshot_<T>), or (ii) export the resolved “as-of T” table contents directly to object storage. In such implementations, the DPS records, for each protected table, the reference timestamp T and corresponding snapshot resolution information (e.g., time travel handle, snapshot table identifier, export job identifier, and/or metadata sufficient to reproduce the time-travel resolution). In further embodiments, the DPS may persist only a time-travel query job identifier and export job identifier as the version indicator, without creating a persistent snapshot table, while still enabling deterministic restoration using the manifest.

In some embodiments, the DPS validates that T is within the supported time travel retention window for each table. If a table does not support access to the requested T, the DPS may adjust T to a valid timestamp (and record the adjusted timestamp in the manifest), exclude the table from the atomic-valid determination, or mark the backup run atomic-invalid for the requested T.

### 11. Applicability Across Various Data Management Platforms

Although FIG. 1 depicts a managed analytics platform 110, in various embodiments the DPS 120 and its external logical abstraction layer may be applied to heterogeneous data management architectures, including data warehouses, lakehouses, relational databases, distributed analytical databases, and object-backed tabular systems, by mapping the anchor point T and per-object resolution semantics to platform-specific versioning constructs or reconstruction sources.

In some embodiments, the atomic backup techniques described herein are applicable across a variety of data management platforms, including, by way of example and without limitation, cloud data warehouses, massively parallel processing (MPP) warehouses, lakehouses, object-backed analytical table systems, globally distributed databases, relational databases (managed or self-hosted), NoSQL/key-value stores, and systems lacking native historical access (e.g., “time travel”). In such embodiments, atomicity is provided as a logical consistency property for a customer-defined group of related data objects, rather than as a requirement that the objects be physically copied simultaneously or that the underlying platform provide a native multi-object snapshot primitive.

For example, in embodiments directed to cloud data warehouses (e.g., Snowflake), atomic backup is non-trivial because multiple object types (e.g., tables, views, streams, tasks) may evolve independently, and native historical access—when available—may be object-scoped rather than group-scoped. In such embodiments, a customer defines a logical consistency group across related objects; the system determines a single reference timestamp (T) for the group; and each object is resolved to its state as-of T using historical access (or other version resolution). The objects may then be exported independently while remaining logically aligned to the same reference timestamp.

In some embodiments directed to MPP warehouses (e.g., Redshift, Synapse SQL pools), atomic backup is non-trivial because native snapshots may capture infrastructure state but may not consistently include external tables, metadata, or dependent artifacts. In such embodiments, the logical consistency group may span internal tables, external references, and metadata; and the system aligns a platform snapshot with versions of the associated metadata to a single logical restore point. In these embodiments, atomicity is enforced externally (e.g., by a data protection service) rather than relying on platform-native grouped snapshot semantics.

In some embodiments directed to lakehouses (e.g., Delta-based systems), atomic backup is non-trivial because data files, transaction logs, catalogs, and compute artifacts may be managed as separate systems with different lifecycles. In such embodiments, the logical consistency group includes one or more lakehouse tables together with associated catalog state and metadata. Each table may be resolved to a specific transaction-log version and/or timestamp T, and atomic backup is achieved by persisting version mappings (e.g., table identifier→log version or commit marker) rather than by freezing underlying storage.

In some embodiments directed to object-backed analytical tables, atomic backup is non-trivial because underlying object storage may be immutable while the logical table state changes over time, and no native cross-object grouping exists. In such embodiments, the system applies logical grouping across related objects and selects object versions based on timestamp and/or version metadata, thereby achieving atomicity without modifying the underlying object store.

In some embodiments directed to globally distributed databases (e.g., Spanner), atomic backup is non-trivial because strong consistency may exist for certain database operations, while other components—such as schema state, access controls (e.g., IAM bindings), and dependent objects—may not be grouped atomically with data. In such embodiments, the logical consistency group spans data, schema, and access controls, and the system aligns these components to the same reference time T to recreate a system-consistent state upon restore.

In some embodiments directed to relational databases (managed or self-hosted), atomic backup is non-trivial because point-in-time recovery (PITR) may exist for data files, while surrounding ecosystem elements—schemas, roles, configurations, and integrations—may not be coordinated to the same restore point. In such embodiments, the logical consistency group spans tables, schemas, roles, and configuration state, and the reference point may be derived from transaction identifiers, log sequence numbers (LSNs), and/or write-ahead log (WAL) positions. Atomic restore may rehydrate the grouped objects to that logical point, including non-data artifacts.

In some embodiments directed to NoSQL/key-value stores (e.g., Bigtable-or Dynamo-style systems), atomic backup is non-trivial because backups may be table-or partition-scoped and related datasets can drift independently. In such embodiments, grouping is applied across tables or containers, a shared logical cutover point is derived from change streams or version markers, and the objects are restored to a mutually consistent state corresponding to that cutover point.

In some embodiments directed to systems without native historical access (i.e., platforms that do not support historical reads or snapshot queries), atomic backup is non-trivial because the platform cannot directly serve “as-of” queries for a requested time. In such embodiments, object versions are reconstructed using one or more of logs, change data capture (CDC), incremental backups, and/or external version tracking, and atomicity is enforced at the logical grouping and metadata layer rather than at the storage layer.

Therefore, for some implementations, atomicity is logical rather than physical, such that objects need not be captured simultaneously provided each object is resolved to a consistent logical time T. In some embodiments, consistency grouping is external and customer-defined, and does not rely on platform-native constructs. In some embodiments, time travel is an optimization rather than a requirement, and platforms without native historical access remain in scope via reconstruction techniques. The same external abstraction may therefore be applied across warehouses, lakehouses, and databases to support broad, platform-agnostic implementations.

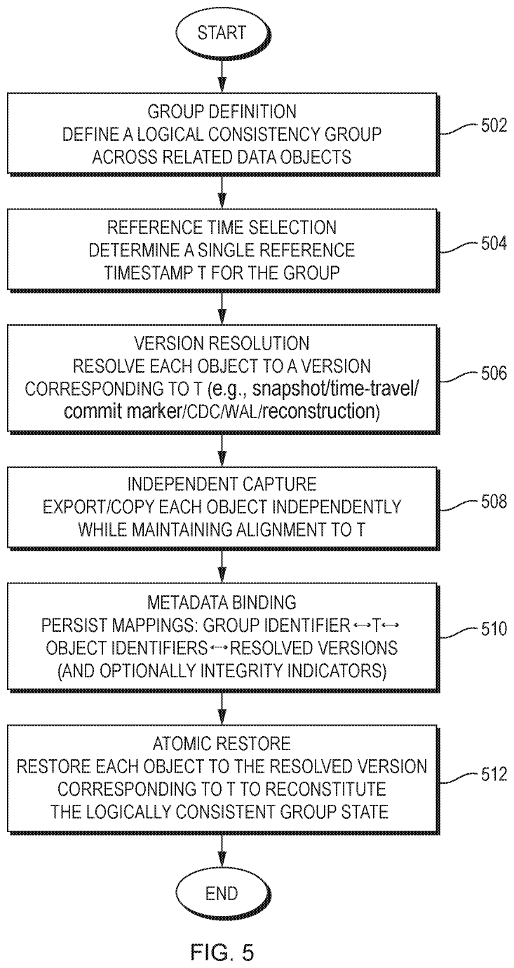

Therefore, as illustrated in FIG. 5, atomic backup of a logical consistency group proceeds according to a process that generally includes a group definition step 502, in which a user (customer) defines a logical consistency group across related data objects. At step 504, the system determines a single reference timestamp (T) for the group. Next, in a version resolution step 506, each object is resolved to a version corresponding to T using any available mechanism (e.g., time travel, snapshots, commit markers, logs, change data capture (CDC), write-ahead logs (WAL), or reconstruction). Independent capture (step 508) exports or persists objects independently while remaining logically aligned to the reference timestamp T. At a metadata binding step 510, group-to-timestamp-to-object-version mappings are persisted (and optionally integrity indicators) to enable deterministic and auditable restore. Finally, an atomic restore step 512 reconstitutes a system state equivalent to that which existed at the reference timestamp T by restoring each object to its resolved version corresponding to T.

### 12. System Implementation Options

It should be understood that the workflow of the example embodiments described above may be implemented in many different ways. In some instances, the various “data processors” may each be implemented by a physical or virtual or cloud-based general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., one or more central processing units, disks, various memories, input/output ports, network ports, etc.) that enables the transfer of information between the elements. One or more central processor units are attached to the system bus and provide for the execution of computer instructions. Also attached to system bus are typically I/O device interfaces for connecting the disks, memories, and various input and output devices. Network interface(s) allow connections to various other devices attached to a network. One or more memories provide volatile and/or non-volatile storage for computer software instructions and data used to implement an embodiment. Disks or other mass storage provides non-volatile storage for computer software instructions and data used to implement, for example, the various procedures described herein.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others. Embodiments may also be implemented in hardware, custom designed semiconductor logic, Application Specific Integrated Circuits (ASICs), Field Programmable Gate Arrays (FPGAs), firmware, software, or any combination thereof.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and system diagrams may include more or fewer elements, be arranged differently, or be represented differently. But it further should be understood that certain implementations may dictate the block and network diagrams and the number of block and network diagrams illustrating the execution of the embodiments be implemented in a particular way.

Embodiments may also leverage cloud or other remote data processing services such as Amazon Web Services, Google Cloud Platform, and similar tools. However the services may also be locally hosted.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the claims that follow.

What is claimed is:

1. A method for providing atomic backup of a plurality of data objects associated with a data management platform, the method comprising:
(a) receiving a request to protect the data objects, the data objects include a plurality of logical containers and subordinate objects;
(b) discovering, via one or more application programming interfaces of the data management platform, the plurality of logical containers and container metadata, the container metadata comprising: (i) one or more attributes indicating whether a platform-supported protection method is available, and (ii) an atomic backup set attribute comprising a group identifier that indicates which logical containers are to be protected together as an atomic backup set;
(c) forming the atomic backup set by selecting, from the plurality of logical containers, those logical containers having the group identifier in common;
(d) determining an anchor point for a data protection method; and
(e) responsive to the one or more attributes indicating availability of the platform-supported protection method is available, invoking the platform-supported protection method for each logical container in the atomic backup set to create backup artifacts corresponding to the anchor point, such that the atomic backup set is protected as-of a given point in time.

2. The method of claim 1 wherein when an attribute indicates the platform-supported protection method is unavailable, invoking a second data protection method not provided via the platform.

3. The method of claim 2, wherein forming the atomic backup set comprises discovering all datasets having a common value for the group identifier and treating the discovered datasets together as the atomic backup set.

4. The method of claim 1, further comprising displaying, via a user interface of a data protection system, the atomic backup set as a virtual container representing the datasets grouped together by the atomic backup set attribute.

5. The method of claim 4, further comprising associating a backup policy with the virtual container, wherein invoking the platform-supported protection method is performed according to the backup policy.

6. The method of claim 1, wherein the backup artifacts include one or more of dataset schema metadata, table definitions, and access control metadata as permitted by the platform.

7. The method of claim 1, further comprising capturing, as part of the backup artifacts, definitions of views that reference objects in at least two datasets of the atomic backup set.

8. The method of claim 7, further comprising restoring, from the backup artifacts, the views together with restored datasets.

9. The method of claim 1, further comprising restoring at least one dataset of the atomic backup set to a different project than a source project.

10. The method of claim 9, wherein restoring comprises restoring at least one dataset under a name different from a source name.

11. The method of claim 9, further comprising modifying at least one view definition to replace a source identifier with a restored identifier corresponding to the different project or different name.

12. The method of claim 1, further comprising generating metadata manifest for the protection method, the metadata representing at least: the group identifier, the anchor point, and identifiers of backup artifacts produced for respective datasets in the atomic backup set.

13. The method of claim 12, further comprising marking the metadata as atomic-valid only when backup artifacts corresponding to the anchor point have been produced for all datasets in the atomic backup set.

14. The method of claim 1, wherein invoking the data protection method comprises initiating backup operations for datasets in the atomic backup set concurrently to reduce temporal variations relative to the anchor point.

15. The method of claim 1, further comprising, upon a failure to create a backup artifact for a first dataset in the atomic backup set, retrying the backup for the first dataset while maintaining the anchor point for the platform-supported protection method.

16. The method of claim 1, further comprising, when a user requests restoration of fewer than all datasets in the atomic backup set from an atomic-valid manifest, presenting a warning indicating cross-dataset inconsistency.

17. The method of claim 1, wherein invoking the data protection method for each dataset comprises resolving a dataset version corresponding to the anchor point based on version metadata, such that the backup artifacts are generated from the resolved versions without pausing ingestion or acquiring global locks.

18. The method of claim 1, wherein, for a platform lacking native historical-version access, invoking the data protection method comprises reconstructing a dataset state as-of the anchor point using change-data-capture logs, write-ahead logs, transaction metadata, or incremental-backup metadata.

19. The method of claim 1, wherein forming the atomic backup set and protecting the datasets as-of a same point in time is performed by an external logical abstraction layer that operates independently of any native platform feature for consistency groups, grouped snapshots, or multi-object transactions.

20. The method of claim 1, wherein determining the anchor point comprises selecting the anchor point from one of: (i) a timestamp generated at backup initiation, (ii) a timestamp provided by a customer or policy, or (iii) a timestamp derived from an event;
and the method further comprises:
validating the anchor point against platform retention or version-history constraints.

21. The method of claim 1, further comprising persisting, in association with the backup artifacts, snapshot-resolution information that deterministically maps each dataset in the atomic backup set to a version used for protection, thereby enabling auditable and reproducible restore operations.

22. A data protection system comprising one or more processors and memory storing instructions that, when executed, cause the data protection system to perform the method of claim 1.

23. A non-transitory computer-readable medium storing instructions that, when executed by one or more processors, cause performance of the method of claim 1.

24. A method for providing atomic backup of a plurality of data objects associated with a data management platform, the method comprising:
(a) identifying, by a data protection system, an atomic backup set comprising a plurality of data objects associated with a common group identifier;
(b) determining a reference timestamp (T) for the atomic backup set;
(c) for each data object in the atomic backup set, resolving an object version corresponding to the reference timestamp (T), comprising:
(i) determining whether the data management platform provides native historical access for the data object;
(ii) when native historical access is available, selecting a platform version indicator that identifies a state of the data object as of the reference timestamp (T); and
(iii) when native historical access is not available, deriving the state of the data object as of the reference timestamp (T) based on version history information obtained from one or more auxiliary sources comprising at least one of change-data-capture logs, write-ahead logs, incremental backup metadata, object versioning records, or transaction metadata;
(d) generating, for each data object, one or more backup artifacts based on the resolved object version corresponding to the reference timestamp (T);
(e) persisting, for the atomic backup set, a manifest that associates the common group identifier, the reference timestamp (T), identifiers of the data objects in the atomic backup set, and per-object snapshot resolution information sufficient to reproduce the resolved object versions corresponding to the reference timestamp (T); and
(f) restoring the atomic backup set using the manifest to restore each data object to the respective resolved object version corresponding to the reference timestamp (T), thereby producing a logically consistent restore point corresponding to the reference timestamp (T).

25. The method of claim 24, wherein the reference timestamp (T) is generated by the data protection system responsive to initiation of an atomic backup operation for the atomic backup set.

26. The method of claim 24, wherein the reference timestamp (T) is provided by a user or derived from a customer-defined policy.

27. The method of claim 24, further comprising validating the reference timestamp (T) against one or more historical-access constraints applicable to the data objects in the atomic backup set, and responsive to a determination that the reference timestamp (T) is invalid for at least one data object, adjusting the reference timestamp (T) to a valid timestamp and recording a resulting adjusted reference timestamp in the manifest.

28. The method of claim 24, wherein the common group identifier is defined by a metadata label or tag associated with at least one of a dataset, table, partition, file-like object, or logical collection, the metadata label or tag indicating membership of the data object in the atomic backup set.

29. The method of claim 24, wherein selecting the platform version indicator comprises selecting at least one of a snapshot identifier, a commit identifier, a transaction bound representation, a checkpoint identifier, or a log offset corresponding to the state of the data object as of the reference timestamp (T).

30. The method of claim 24, wherein persisting the backup artifacts comprises exporting the backup artifacts to object storage.

31. The method of claim 24, further comprising determining whether backup artifacts have been successfully generated for all data objects in the atomic backup set for the reference timestamp (T), and responsive to determining that all data objects are successfully completed, marking a backup run as atomic-valid, and responsive to determining that at least one data object is not successfully completed, marking the backup run as atomic-invalid.

32. The method of claim 24, wherein the data management platform comprises Google BigQuery, and resolving the object version corresponding to the reference timestamp (T) comprises performing a time-travel query against a table to access a table state as of the reference timestamp (T).

33. The method of claim 28, wherein the metadata label or tag comprises a key-value pair including a prefix identifying a group type and a group name.

34. The method of claim 24, wherein identifying the atomic backup set and resolving the object versions corresponding to the reference timestamp (T) are performed by an external logical abstraction layer that operates independently of any native platform feature for multi-object consistency groups, grouped snapshots, or multi-object transactions.
